(19) United States
(12) Patent Application Publication
(10) Pub. No.: US 2026/0059060 A1
(43) Pub. Date: Feb. 26, 2026

(54) SCANNER PERFORMING SCAN PROCESS BASED ON RECOMMENDED PARAMETER SET OUTPUTTED BY TRAINED MACHINE LEARNING MODEL

(71) Applicant: BROTHER KOGYO KABUSHIKI KAISHA, Nagoya (JP)

(72) Inventor: Fumitake TAJIRI, Nagoya (JP)

(21) Appl. No.: 19/288,340

(22) Filed: Aug. 1, 2025

(30) Foreign Application Priority Data
Aug. 21, 2024 (JP) 2024-139793

(51) Int. Cl. H04N 1/00; G06F 3/0484; G06F 16/3329

(52) U.S. Cl. CPC H04N 1/00811; G06F 3/0484; G06F 16/33295; H04N 1/00806

(57) ABSTRACT

A scanner includes a scanning engine. The scanner outputs one or more questions related to generation of scan data through a user interface, and receives one or more answers through the user interface when a scan instruction is received. The scanner performs transmits question-and-answer information to a server through a communication interface. The question-and-answer information includes the questions and answers, and associates each question with a corresponding answer. The scanner performs a scan process when a recommended parameter set is received from the server through the communication interface. The recommended parameter set is outputted by a trained machine learning model based on the question-and-answer information. The scan process is based on the recommended parameter set. The scan process includes reading an original using the scanning engine to generate scan data. The scanner outputs the scan data or an object based on the scan data.

### REFERENCE TO RELATED APPLICATIONS

This application claims priority from Japanese Patent Application No. 2024-139793 filed on Aug. 21, 2024. The entire content of the priority application is incorporated herein by reference.

### BACKGROUND ART

Known scanners scan a document in accordance with parameters for various scan settings and output image data of the scanned image. For example, a known scanner prompts the user to select the type of image on the document and then adjusts a correction amount for show-through based on the selected type of image.

### SUMMARY

In the known technology, the amount of show-through correction is determined based on the type of image selected by the user, but the amount of show-through correction is just one of the scan settings for which parameters can be adjusted. Consequently, the known technology leaves room for improvement with regard to obtaining scanning results suitable for the image on the original document.

In view of the foregoing, it is an object of the present disclosure to provide a scanner capable facilitating the achievement of a scanning result appropriate for the original.

In order to attain the above and other objects, the present disclosure provides a scanner. The scanner is configured to output one or more questions related to generation of scan data through the user interface. The scanner is configured to receive one or more answers through the user interface. The scanner is configured to transmit question-and-answer information to a server. The scanner is configured to read an original based on the first recommended parameter set, using the scanning engine to generate first scan data.

In the above structure, the question-and-answer information is transmitted to the server, and the recommended parameter set is generated based on the question-and-answer information. Accordingly, a likelihood of obtaining a scanning result appropriate for the original can be increased.

### BRIEF DESCRIPTION OF DRAWINGS

FIG. 1 is an illustration of a configuration of a multifunction peripheral.

FIG. 2 is a flowchart illustrating a scanning process.

FIG. 3A is an illustration of a standby screen.

FIG. 3B is an illustration of an AI support selection screen.

FIG. 4 is a flowchart illustrating an auto settings process.

FIG. 5 is a flowchart illustrating a confirmation process.

FIGS. 6A and 6B are illustrations of confirmation screens.

FIG. 7 is an illustration of a rejection reason selection screen.

FIG. 8 is an illustration of a parameter screen.

FIG. 9 is a flowchart illustrating an interactive process.

FIGS. 10-19 are illustrations of Q&A screens.

### DESCRIPTION

Below, an embodiment of a scanner according to the present disclosure will be described while referring to the accompanying drawings. In this specification, the scanner of the present disclosure is applied to a multifunction peripheral (hereinafter “MFP”) having various functions, including an image-reading function and a communication function.

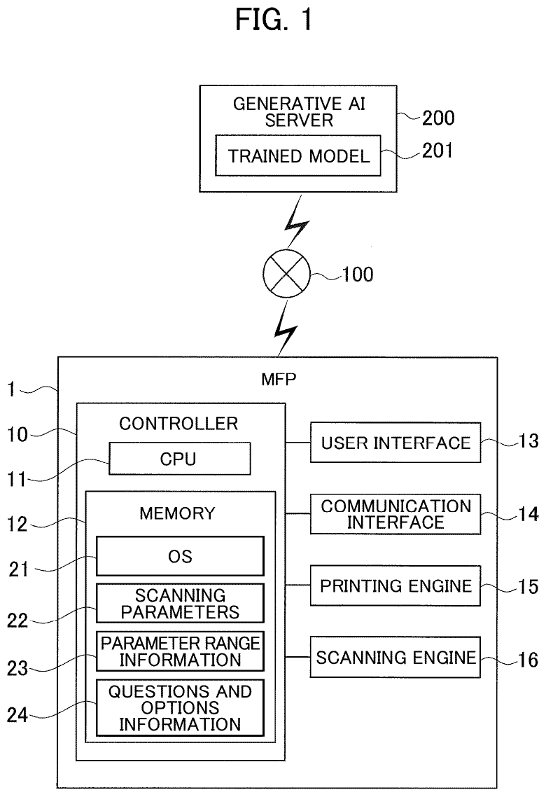

FIG. 1 shows an example of an MFP 1 according to the present embodiment. The MFP 1 includes a controller 10. The controller 10 includes a CPU 11 and a memory 12. The MFP 1 includes a user interface 13, a communication interface 14, a printing engine 15, and a scanning engine 16, all of which are electrically connected to the controller 10. Note that the controller 10 in FIG. 1 is a general concept that covers all hardware and software used for controlling the MFP 1 and is not limited to representing a single piece of hardware actually present in the MFP 1. The MFP 1 is an example of a scanner.

The CPU 11 of the MFP 1 executes various processes according to programs read from the memory 12 and based on user operations. The memory 12 of the MFP 1 stores various programs including an operating system (hereinafter “OS”) 21, and various data including scanning parameters 22, parameter range information 23, and questions and options information 24. The memory 12 is used as a work area when executing various processes. A buffer included in the CPU 11 is an example of the memory 12. The programs and data will be described later in greater detail. The scanning parameters 22 may be referred to as a scanning parameter set.

Examples of the memory 12 may include ROM, RAM, or a hard disk drive built into the MFP 1, or may be a storage medium that is readable and writable by the CPU 11. A USB memory connected to the MFP 1, an external memory such as a hard disk drive, and a memory or hard disk drive included in a device connected to the MFP 1 via the communication interface 14 are all examples of memory.

A computer-readable storage medium is a non-transitory medium. Non-transitory media include CD-ROM and DVD-ROM in addition to the above examples. A non-transitory medium is also a tangible medium. On the other hand, electric signals that convey programs downloaded from a device on the Internet such as a server are a computer-readable signal medium, which is one type of computer-readable medium but is not a non-transitory computer-readable storage medium.

The user interface 13 includes a touchscreen. The touchscreen includes hardware that displays screens for reporting information to the user, and hardware that receives user operations. The user interface 13 may include a combination of a display and hardware buttons.

The communication interface 14 includes hardware for communicating with external devices. The communication interface 14 includes functions supporting such communication standards as Wi-Fi (U.S. trademark of Wi-Fi Alliance CORPORATION), Ethernet, and Universal Serial Bus (USB). The MFP 1 may also include a plurality of communication interfaces 14 supporting a plurality of communication standards.

The printing engine 15 includes configurations for printing images on sheets or other print media. The method of image formation used by the printing engine 15 may be the electrophotographic method or the inkjet method, for example. The printing engine 15 may be configured to be capable of multicolor printing or may be configured to be only capable of single-color printing.

The scanning engine 16 includes a configuration for scanning a document placed on a flatbed or a document set in a document feeder and conveyed to a reading position, and for generating scan data as the scanning results. In the present embodiment, the scanning engine 16 can perform both color scanning for reading a document as a color image, and monochrome scanning for reading a document as a monochrome image.

As shown in FIG. 1, the MFP 1 can connect to an internet 100 via the communication interface 14 and can access a generative AI server 200 via the internet 100, for example. The generative AI server 200 includes a trained model 201. The generative AI server 200 may be a dedicated server prepared by the vendor of the MFP 1 or may be a server made available on the internet 100 by an AI company. One example of an AI company is OpenAI. The generative AI server 200 is an example of the server using the trained machine learning model.

The trained model 201 is a trained machine learning model which has been trained in advance with various types of data to be able to output response data based on inputted data.

For example, the trained model 201 has been trained to output recommended parameters for generating scan data. Trained models on servers prepared by AI companies are trained using big data, for example. Therefore, such trained models can be expected to be capable of analyzing inputted data to identify recommended parameters with high accuracy. The trained model 201 may also be a model prepared by the vendor of the MFP 1.

The generative AI server 200 may include an application programming interface (API) for instructing the trained model 201 to output recommended parameters. The MFP 1 may be capable of instructing the trained model 201 to output recommended parameters by using the API included in the generative AI server 200 for instructing the trained model 201 to output recommended parameters, for example.

Alternatively, the generative AI server 200 may accept instructions in the form of a prompt, i.e., in the form of a character string. For example, the MFP 1 may be capable of instructing the trained model 201 to output recommended parameters by inputting input data into the generative AI server 200 together with a prompt instructing the generative AI server 200 to output recommended parameters determined based on the input data.

A procedure to scan an image performed by the MFP 1 will be described next. In the following description, actions such as “determine,” “extract,” “select,” “calculate,” “set,” “identify,” “acquire,” “obtain,” “receive,” and “control” represent processes performed by the CPU 11. Processes performed by the CPU 11 include processes that control hardware using APIs included in an operating system (OS). In the description, an operation of each program is described without referring to the OS. For example, expressions, such as “program B controls hardware C” may indicate “program B controls hardware C by using an API included in the OS”. Further, processes performed by the CPU 11 according to instructions described in a program may be described in abbreviated terms, such as “the CPU 11 executes” or “the program executes”.

In the description, the terms “notice”, “notification”, “report”, “reply”, “response”, and “answer” are used not only to refer to communication directed to a person, but also refer to communication between devices or information transmission or reception between devices.

Note that the term “acquire” and in this specification is used as a concept that does not necessarily require a request. In other words, a process by which the CPU 11 receives data without requesting that data is included in the concept of “the CPU 11 acquires data.” This holds true for the term “obtain”. The term “data” described herein is expressed as bit strings that can be read by a computer. Data of different formats are treated as the same data when the content of the data is essentially the same. The same holds true for “information” in this specification. An “instruction,” and a “request,” is processed by outputting information indicating the “instruction,” and the “request.” The terms “instruction” and “request” may also be used to describe information indicating an “instruction,” and a “request.”

Further, a process performed by the CPU 11 to determine whether information A indicates circumstance B may be described conceptually as “determining whether circumstance B based on information A.” A process in which the CPU 11 determines whether information A indicates circumstance B or circumstance C may be described conceptually as “determining whether circumstance B or circumstance C based on information A.”

In this specification, a setting item may simply be referred to as a “setting.” Setting values may be referred to simply as “settings.” The term “variable” refers to a container holding a value, which may be referenced or modified during execution of processing. The term “value” or “setting value” refers to specific data assigned to a variable or parameter. The term “parameter” refers to a variable element that receives input or to the value assigned to such an element, depending on the context. A parameter is used as a configurable element that influences processing conditions or behaviors. The term “setting item” refers to a representation, identifier, or name of a variable or parameter.

The process of storing a setting value in memory may be referred to simply as “setting.” An operation for setting a setting value or the act of inputting a setting value may also simply be referred to as “setting.”

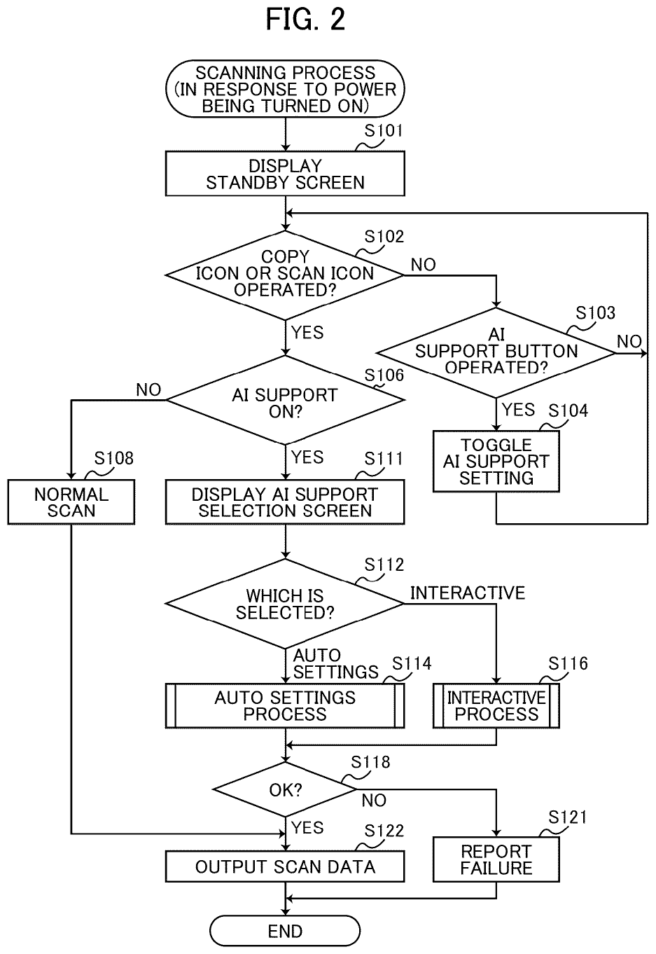

A scanning process that uses the MFP 1 to scan a document and output the resulting scan data will be described next with reference to the flowchart in FIG. 2. The CPU 11 of the MFP 1 executes this scanning process in response to the power of the MFP 1 being turned on, for example. Processes, or steps attributed to the MFP 1 is actually executed by the CPU 11. Note that the MFP 1 can execute various other processes in addition to the scanning process of FIG. 2.

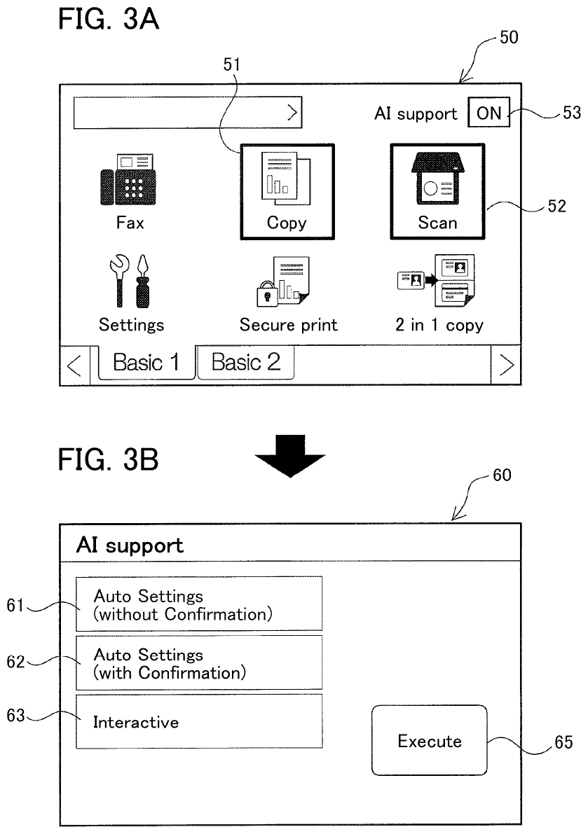

While in a standby state, in S101 the MFP 1 displays a standby screen on the user interface 13. FIG. 3A shows an example of a standby screen 50 that the CPU 11 displays. In this example, the standby screen 50 includes a Copy icon 51, a Scan icon 52, and an AI Support button 53. In addition to these icons, the standby screen 50 includes various other icons that can accept an instruction to perform one of the various functions available on the MFP 1. Through a user operation on a displayed icon, the MFP 1 receives a selection of the function associated with the operated icon.

In S102 the CPU 11 determines whether an operation has been received on one of the Copy icon 51 or Scan icon 52. When the CPU 11 determines that neither an operation on the Copy icon 51 nor an operation on the Scan icon 52 has been received (S102: NO), in S103 the CPU 11 determines whether an operation on the AI Support button 53 has been received. The Copy icon 51 is an icon that accepts an instruction to initiate a copying procedure, which includes the execution of a scan. The Scan icon 52 is an icon that accepts an instruction to initiate a scanning procedure. Note that the various icons may be referred to as “buttons” and the various buttons may also be called “icons.”

The AI Support button 53 accepts a selection to enable or disable AI support. When AI support is enabled, the CPU 11 can use the trained model 201 to execute a scan based on recommended parameters outputted by the generative AI server 200. AI support is enabled when the AI Support button 53 is set to “ON”, as shown in the example of FIG. 3A. The recommended parameters may be referred to as a recommended parameter set.

When the CPU 11 determines that an operation on the AI Support button 53 has been received (S103: YES), in S104 the CPU 11 toggles the AI support setting between “ON” and “OFF”. Specifically, in a case where the AI support button 53 is operated while AI support is “ON”, the CPU 11 switches AI support from “ON” to “OFF”. In a case where the AI support button 53 is operated while AI support is “OFF”, the CPU 11 switches AI support from “OFF” to “ON”.

Following S104 or when the CPU 11 determines that an operation on the AI Support button 53 has not been received (S103: NO), the CPU 11 returns to S102 and waits until an operation is received on one of the Copy icon 51, Scan icon 52, or AI Support button 53. The CPU 11 can also receive instructions unrelated to scanning procedures and perform operations based on those instructions. After completing any such operations, the CPU 11 returns to S101 and redisplays the standby screen 50.

When the CPU 11 determines in S102 that an operation on either the Copy icon 51 or Scan icon 52 has been received (S102: YES), in S106 the CPU 11 determines whether AI support is “ON”. In a case where the Copy icon 51 or the Scan icon 52 has been operated while AI support is “ON”, the CPU 11 can execute a scan while receiving AI support.

When the CPU 11 determines that AI support is not “ON” (S106: NO), in S108 the CPU 11 performs the scan according to the normal procedure (normal scan). The normal scan may be a scan process without using any trained model. That is, the CPU 11 controls the scanning engine 16 to execute a scan and generate scan data using the scanning parameters 22 stored in the memory 12. Hence, when an operation on the Copy icon 51 or the Scan icon 52 is received while AI support is “OFF”, the CPU 11 performs the scan without AI support.

The scanning parameters 22 are default parameters used for various scanning-related settings. The scanning parameters 22 are a parameter set that include parameters related to scanning and parameters related to image processing of the scanning results. Examples of scanning-related parameters are a parameter specifying the reading resolution, and a parameter specifying whether to perform color scanning or monochrome scanning. Examples of parameters related to image processing are parameters related to contrast and brightness and parameters for correction processes including fine line correction, background color correction, and skew correction. In other words, the “scan data” generated by executing a scan is the result obtained by: reading an original document according to the former parameters to generate image data; and performing image processing on the generated image data according to the latter parameters. The scanning parameters 22 may further include a parameter indicating the type of image on the document, and a parameter specifying the file format of the file to be outputted.

The scanning parameters 22 may be stored on the MFP 1 when the MFP 1 is shipped from the factory or may be values that an administrator or user of the MFP 1 is able to modify after receiving the shipped MFP 1. The MFP 1 may also be able to store a different set of values for the scanning parameters 22, depending on output destination.

When the CPU 11 determines in S106 that AI support is “ON” (S106: YES), in S111 the CPU 11 displays an AI support selection screen on the user interface 13. FIG. 3B shows an example of the AI support selection screen 60 displayed by the CPU 11. In this example, the AI support selection screen 60 includes an “Auto Settings (without Confirmation)” button 61, an “Auto Settings (with Confirmation)” button 62, an “Interactive” button 63, and an Execute button 65.

The “Auto Settings (without Confirmation)” button 61 is a button for selecting a scanning procedure in which the CPU 11 performs a scan using recommended scanning parameters outputted from the trained model 201 and then generates and outputs the scan data without receiving user confirmation. The “Auto Settings (with Confirmation)” button 62 selects a scanning procedure in which the CPU 11 performs a scan using recommended scanning parameters outputted from the trained model 201, generates scan data, and outputs the scan data after receiving user confirmation. The “Interactive” button 63 selects a scanning procedure that includes a procedure performed prior to the scan for asking the user questions about the scan and receiving the user's responses. Each procedure will be described later in detail.

The CPU 11 waits until an operation on one of the buttons 61-63 followed by an operation on the Execute button 65 are received. Note that an operation on the Execute button 65 can only be accepted while one of the buttons 61-63 is selected. When an operation on the Execute button 65 is received, in S112 the CPU 11 determines which of the buttons 61-63 has been selected by the user.

When the CPU 11 determines that the user selected either the “Auto Settings (without Confirmation)” button 61 or the “Auto Settings (with Confirmation)” button 62 (S112: Auto Settings), in S114 the CPU 11 executes an auto settings process in response to receiving an operation on the Execute button 65. An instruction issued in a case where an operation on the Execute button 65 is received while the “Auto Settings (without Confirmation)” button 61 or the “Auto Settings (with Confirmation)” button 62 is selected is an example of the specific scan instruction. An instruction issued in a case where an operation on the Execute button 65 is received while the “Auto Settings (without Confirmation)” button 61 is selected is an example of the second scan instruction. An instruction issued in a case where an operation on the Execute button 65 is received while the “Auto Settings (with Confirmation)” button 62 is selected is an example of the first scan instruction.

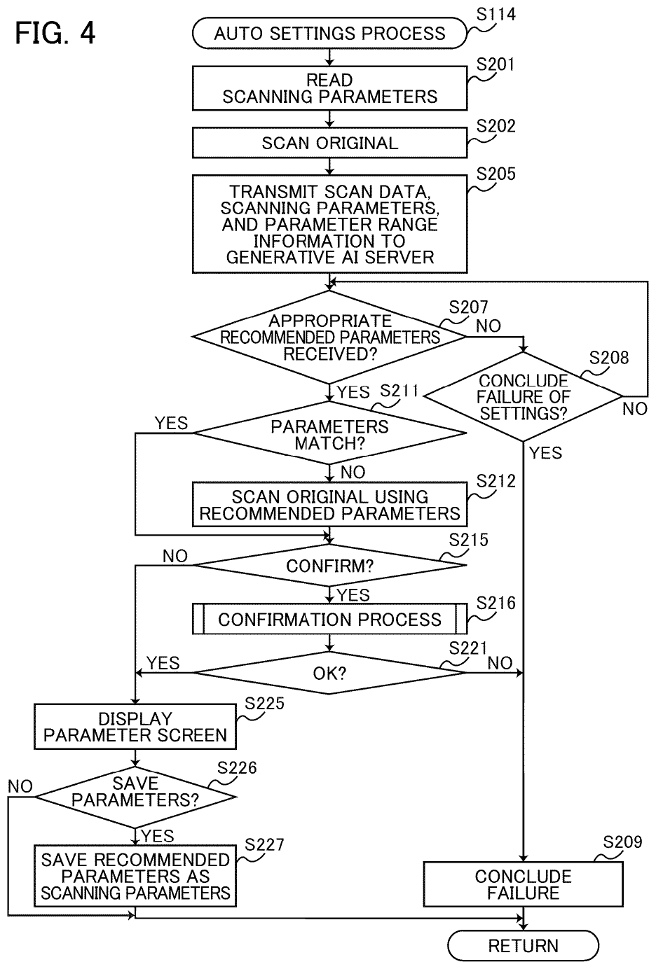

Steps in the auto settings process will be described next with reference to the flowchart in FIG. 4. In S201 of the auto settings process, the CPU 11 reads the scanning parameters 22 stored in the memory 12. In S202 the CPU 11 performs a scan using the scanning parameters 22. Specifically, the CPU 11 controls the scanning engine 16 to read an image of the document placed on the flatbed or set in the document feeder and generates scan data.

In S205 the CPU 11 transmits various data to the generative AI server 200 via the communication interface 14, including the scan data generated in S202, the scanning parameters 22 used in the scan of S202, and the parameter range information 23. That is, in S205 the CPU 11 instructs the generative AI server 200 to have the trained model 201 analyze various transmitted data (the scan data and the scanning parameters 22 in this example) and to return recommended parameters within the ranges specified by the parameter range information 23 in response. The data transmitted by the CPU 11 in S205 will also be referred to as “transmission data”for convenience.

The CPU 11 may also instruct the generative AI server 200 to return recommended parameters by sending the transmission data to the generative AI server 200 via a dedicated API. Alternatively, the CPU 11 may instruct the generative AI server 200 to return recommended parameters by sending the transmission data with a prompt specifying instructions to the generative AI server 200. The scan data that the MFP 1 sends to the generative AI server 200 may be raw data, i.e., unaltered data in the scanning results obtained by the scanning engine 16, or may be processed data that has undergone a format conversion on the MFP 1.

The parameter range information 23 (see FIG. 1) specifies the range of possible parameter for each setting (each setting item, or parameter type) used in scanning. Examples of settings used in scanning are settings of color, resolution, contrast, brightness, image type, fine line correction, background color correction, and skew correction. The parameter range information 23 is stored in the memory 12. The CPU 11 may instruct the generative AI server 200 to return recommended parameters within the respective ranges specified in the parameter range information 23 by sending the transmission data to the generative AI server 200 via a dedicated API or by sending the transmission data together with a prompt specifying the instructions to the generative AI server 200. The parameter range information 23 is an example of information related to a range within which a parameter can be set and an example of information related to a condition for a value settable for a parameter.

The color setting indicates whether color scanning is to be performed, and the parameters that can be set for the color setting are “Color” and “Monochrome.” The resolution setting specifies the scanning resolution, and the parameters that can be set as the resolution setting are “200 dpi,” “300 dpi,” and “600 dpi.” The contrast setting and brightness setting are related to the correction of scanning results, and the parameters that can be set for these settings are values from −5 to 5 in increments of 1. The image type setting specifies the type of image on the original, and the possible parameters are “Auto,” “Text,” “Photo,” and “Receipt.” The fine line correction, background color correction, and skew correction settings (setting items) includes settings regarding whether each correction is to be applied to the scanning results, and the parameters that can be set for each item are “Yes” and “No.” The settings may include a parameter indicating how much each correction is to be applied. The setting items and ranges of values in the parameter range information 23 described above are merely one example and are not limited to this example.

By passing the parameter range information 23 specifying the range of possible parameter settings to the generative AI server 200 and requesting recommended parameters corresponding to these ranges of possible settings, the CPU 11 reduces the possibility of the generative AI server 200 recommending inappropriate parameters.

The generative AI server 200 may also perform various processes on the data received from the MFP 1 prior to inputting the data into the trained model 201 to the extent that the data content is not significantly altered. In this specification, inputting data sent from the MFP 1 into the trained model 201 after performing various processes falls within the concept of the MFP 1 inputting the data into the trained model 201.

The generative AI server 200 can analyze inputted data using the trained model 201 and can generate response data including information on recommended parameters. The generative AI server 200 then outputs the generated response data addressed to the MFP 1, whereby the MFP 1 receives information specifying recommended parameters from the generative AI server 200 via the communication interface 14.

As with the inputted data, the generative AI server 200 may perform various processes on data outputted from the trained model 201 before transmitting the data to the MFP 1 to the extent that the content of the data is not significantly altered. In this specification, the MFP 1 receiving data that has undergone various processes after being outputted from the trained model 201 falls within the concept of the MFP 1 receiving data outputted from the trained model.

After sending the transmission data to the generative AI server 200 in S205, in S207 the CPU 11 determines whether appropriate recommended parameters in a response have been received from the generative AI server 200. When the response received from the generative AI server 200 contains recommended parameters and these parameters fall within respective the ranges specified by the parameter range information 23, the CPU 11 determines that appropriate recommended parameters have been received (S207: YES).

However, when a response has not been received from the generative AI server 200 or when the response received from the generative AI server 200 does not contain one or more recommended parameters, or when the response contains one or more recommended parameters that fall outside the corresponding ranges specified in the parameter range information 23 or when the response is otherwise inappropriate, then the CPU 11 determines that appropriate recommended parameters have not been received (S207: NO). In other words, the CPU 11 may receive a response from the generative AI server 200 (i.e., a response by the trained model 201) that has not been generated in accordance with the instructions in the transmission data. Accordingly, when the CPU 11 receives a response that does not conform with the instructions in the transmission data sent in S205, the CPU 11 determines that appropriate recommended parameters have not been received, thereby reducing the possibility of performing a scan using inappropriate parameters.

When the CPU 11 determines that appropriate recommended parameters have not been received (S207: NO), in S208 the CPU 11 determines whether to conclude that the settings process has failed. When the CPU 11 determines not to conclude that the settings process failed (S208: NO), the CPU 11 returns to the determination in S207.

When the CPU 11 determines that appropriate recommended parameters have not been received from the generative AI server 200 (S207: NO), the CPU 11 may resend the same transmission data that has been transmitted in S205 to the generative AI server 200 before making the determination in S208. Alternatively, when the CPU 11 determines in S208 not to conclude that the settings process has failed (S208: NO), the CPU 11 may resend the same transmission data transmitted in S205 to the generative AI server 200 before making the determination in S207 again. The trained model 201 may output a different response from the previous time even when the same transmission data is resent to the generative AI server 200, i.e., reinputted into the trained model 201. In other words, by resending the transmission data, the response outputted by the trained model 201 could contain appropriate recommended parameters.

When the CPU 11 determines to conclude that the settings process has failed (S208: YES), in S209 the CPU 11 concludes that appropriate recommended parameters could not be obtained with the support of the generative AI server 200, and sets the settings result (a specific flag) to “Failure,” and discards the generated scan data. The CPU 11 may conclude that the settings process has failed when a predetermined time has elapsed after sending the transmission data in S205 without receiving a response from the generative AI server 200 or when no appropriate response has been received, even after transmitting the data to the AI server 200 a predetermined number of times, for example. Further, the CPU 11 may conclude that the settings process has failed in a case where after sending transmission data, the CPU 11 has determined the predetermined number of times in S208 whether a failure has occurred without having received appropriate recommended parameters. That is, the CPU 11 may conclude that the settings process has failed when the CPU 11 makes NO determination in S207 the predetermined number of times. Note that when the CPU 11 determines that the response received from the generative AI server 200 does not contain appropriate recommended parameters, the CPU 11 may conclude that a failure has occurred without resending the transmission data or repeating the determination in S207.

When the CPU 11 determines that appropriate recommended parameters have been received (S207: YES), in S211 the CPU 11 determines whether the recommended parameters received from the generative AI server 200 are the same as the scanning parameters 22 used when performing the scan in S202. As with the scanning parameters 22, the recommended parameters are information specifying a plurality of parameters to be used for scanning, i.e., parameters for each of the plurality of settings used for scanning.

When the CPU 11 determines that any of the settings (setting items) has a different parameter between the recommended parameters received from the generative AI server 200 and the scanning parameters 22, the CPU 11 reaches a NO determination in S211, in S212 the CPU 11 generates scan data by controlling the scanning engine 16 to read the image on the document using the recommended parameters. In other words, the CPU 11 makes NO determination when the recommended parameters includes a parameter for one setting item different from the parameter for that setting item in the scanning parameters 22.

After completing the scan in S212 or when determining in S211 that the recommended parameters are the same as the scanning parameters 22 (S211: YES), in S215 the CPU 11 determines whether to prompt the user for confirmation. When the recommended parameters and the scanning parameters 22 are the same, it is unlikely that the scanning results will change even when the scan is performed again. Thus, the CPU 11 does not repeat the scan in S212 when the parameters match to avoid unnecessary scanning.

Specifically, in S215 the CPU 11 determines whether the user selection received through the AI support selection screen 60 (see FIG. 3B) is either the “Auto Settings (without Confirmation)” button 61 or the “Auto Settings (with Confirmation)” button 62. When the CPU 11 determines that the user has selected the “Auto Settings (with Confirmation)” button 62 (S215: YES), in S216 the CPU 11 executes a confirmation process.

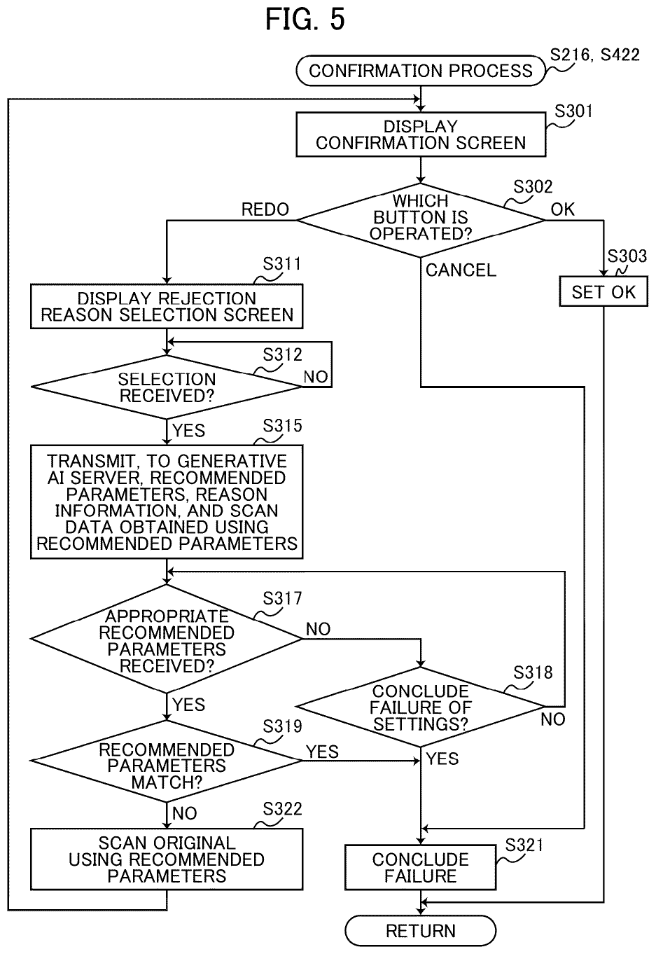

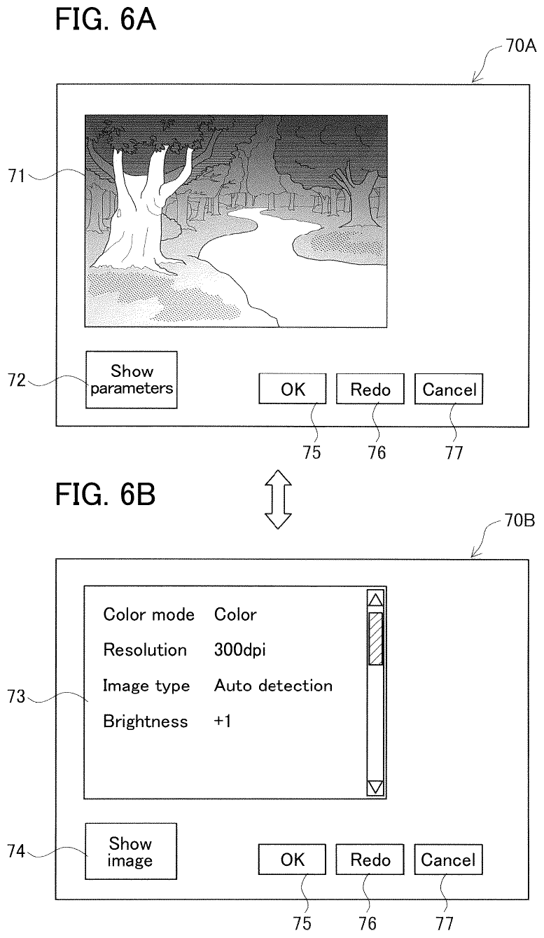

Steps in the confirmation process will be described next with reference to the flowchart in FIG. 5. In S301 of the confirmation process, the CPU 11 displays a confirmation screen on the user interface 13. FIG. 6A shows an example of a confirmation screen 70A displayed by the CPU 11. Alternatively, the CPU 11 may display a confirmation screen 70B shown in FIG. 6B.

The confirmation screen 70A shown in FIG. 6A includes an image 71 and a button 72. The image 71 is an image of the scanning results represented by either the scan data generated in S212 when S212 is performed or the scan data generated in S202 when the parameters match (S212 is skipped). The button 72 is a button for accepting an instruction to display the confirmation screen 70B. The confirmation screen 70B shown in FIG. 6B includes parameter information 73 and a button 74. The parameter information 73 specifies the recommended parameters used in S212 when S212 is performed or the scanning parameters 22 used in S202 when the parameters match. The button 74 is a button for accepting an instruction to display the confirmation screen 70A.

In other words, when the user has operated the “Auto Settings (with Confirmation)” button 62 in the AI support selection screen 60 (FIG. 3B), the user can review the image represented by the generated scan data based on the image 71 in the confirmation screen 70A and can review the parameters used for scanning in the parameter information 73 of the confirmation screen 70B. By being able to check both the image and the parameters, the user can easily determine whether the results are acceptable.

Both the confirmation screen 70A and confirmation screen 70B also include an OK button 75, a Redo button 76, and a Cancel button 77. The OK button 75 is a button for accepting an instruction to output this scan data. The Redo button 76 is a button for accepting an instruction to repeat the process for receiving recommended parameters from the trained model 201. The Cancel button 77 is a button for accepting an instruction to cancel the procedure for generating scan data with AI support.

After reviewing the displayed confirmation screen 70A and confirmation screen 70B, the user operates one of the OK button 75, Redo button 76, and Cancel button 77. In S302 the CPU 11 determines which of the OK button 75, Redo button 76, and Cancel button 77 has been operated. When an operation on the OK button 75 has been received (S302: OK), in S303 the CPU 11 sets the settings result (a flag) to indicate “OK” and subsequently ends the confirmation process. In other words, in S303 the CPU 11 determines that the scan result is accepted (approved) by the user. That is, in S303 the CPU 11 determines that the scan data and the parameters used for generating the scan data are accepted (or approved) by the user. The settings result (flag) indicating “OK” may signify the settings result indicating that the scan result is accepted (approved) by the user or indicating that the scan data and the parameters used for generating the scan data are accepted (or approved) by the user.

That is, a user who considers this scan data to be satisfactory will operate the OK button 75 to request that the scan data be outputted. When the OK button 75 is operated, the CPU 11 performs an output process based on the scan data generated in S212 when S212 is performed or the scan data generated in S202 when the parameters matched. The instruction issued in response to an operation on the OK button 75 is an example of the outputting instruction. The confirmation screens 70A and 70B through which an operation on the OK button can be received is an example of the outputting confirmation screen.

When the CPU 11 determines that an operation on the Redo button 76 has been received (S302: Redo), in S311 the CPU 11 displays a rejection reason selection screen on the user interface 13 for selecting a reason for rejection. In S312 the CPU 11 waits while a user selection is not made (S312: NO). When a user selection is received (S312: YES), the CPU 11 generates reason information based on the received selection.

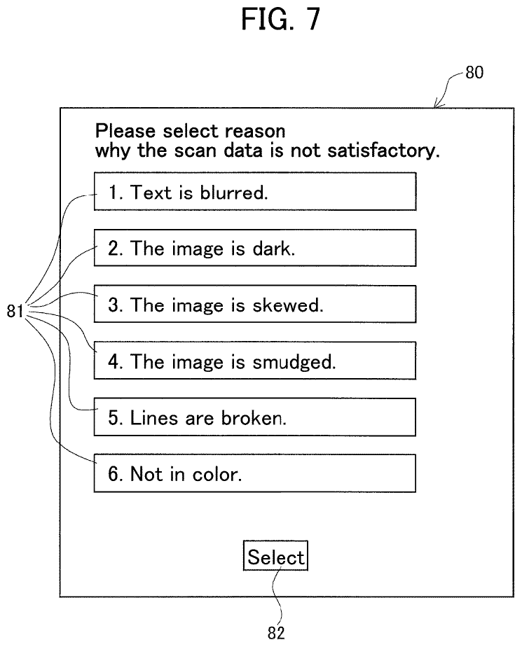

FIG. 7 shows an example of a rejection reason selection screen 80 displayed by the CPU 11. In this example, the rejection reason selection screen 80 includes a plurality of options 81 indicating various reasons for which the user may have determined that this scan data is not satisfactory, and a Confirm button 82. The user first selects one of the options 81 that indicates the reason the user has determined the scan data to be unacceptable and then operates the Confirm button 82. Each of the options 81 corresponds to a parameter setting (a setting item of a parameter) used in this scan. Based on the option 81 selected in S312, the CPU 11 generates reason information. The reason information is information for indicating a reason why the recommended parameters received are rejected. The reason information includes an instruction to correct the one or more parameters of a setting (the one or more parameters of the setting item) associated with this option 81. Each of the options 81 indicates correction contents (details) to be corrected for each setting (each setting item). That is, each of the options 81 indicates how the parameters is to be modified. The process of S312 is an example of the correction content reception process.

The reason information may be information specifying the option 81 selected in S312 or may be information set by the CPU 11 based on the selected option 81, e.g., information related to the setting (the setting item) associated with the selected option 81. The CPU 11 may be able to accept selections of multiple options 81 in the rejection reason selection screen 80. When the CPU 11 accepts selections of multiple options 81 the reason information may include information on each selected option 81 or information based on each selected option 81. The CPU 11 may be capable of accepting an operation on the Confirm button 82 while none of the options 81 have been selected.

Specifically, when “1. Text is blurred” is selected in the rejection reason selection screen 80, the CPU 11 generates reason information including a correction instruction to increase the contrast setting (an instruction to adjust one or more parameters for a contrast setting item to increase the contrast) or an instruction to perform fine line correction (an instruction to adjust one or more parameters for an item of fine line to clarify fine line). When “2. The image is dark” is selected, the CPU 11 generates reason information including an instruction to increase the brightness setting (an instruction to adjust one or more parameters for the brightness setting item to increase brightness). When “3. The image is skewed” is selected, the CPU 11 generates reason information including an instruction to perform skew correction (an instruction to adjust one or more parameters for the skew correction). When “4. The image is smudged” is selected, the CPU 11 generates reason information including an instruction to perform background color correction (an instruction to adjust one or more parameters for the background color correction item). When “5. Lines are broken” is selected, the CPU 11 generates reason information including an instruction to increase the resolution (an instruction to adjust one or more parameters for the resolution item). In this case, the reason information may include instruction to adjust one or more parameters for the fine line correction. When “6. Not in color” is selected, the CPU 11 generates reason information including an instruction to change the color setting to color scanning (an instruction to change the parameter for the color or monochrome scanning item).

Note that the rejection reason selection screen 80 may also include options giving instructions in the opposite direction of these options 81, such as “The image is too bright” and “Not monochrome.” By displaying an option 81 for each setting in the scanning parameters and accepting user selections, the CPU 11 can generate reason information that includes correction instructions. The reason information may be information indicating one or more options selected through the rejection reason screen 80 and information relevant to identifying type of corrections to be performed and degrees of that corrections.

In S315 the CPU 11 sends various data to the generative AI server 200 via the communication interface 14, including the scan data, scanning parameters (recommended parameters used for generating the scan data), and reason information. For convenience, the data that the CPU 11 sends in S315 will be called “redo data.” That is, in S315 the CPU 11 instructs the generative AI server 200 to have the trained model 201 analyze the redo data and to return recommended parameters reflecting the reason information. The process of S315 is an example of the updating process and an example of the transmission process. Thus, when the user operates the Redo button 76 (FIG. 6 A or 6B), the CPU 11 does not perform output based on the scan data generated in S212 when S212 is performed or the scan data generated in S202 when the parameters match but instead resends the redo data to the generative AI server 200. The instruction issued through the operation on the redo button 76 is an example of the correction instruction.

The MFP 1 may instruct the generative AI server 200 to return recommended parameters reflecting the reason information by sending the redo data to the generative AI server 200 via the API or by sending the redo data and a prompt specifying instructions to generate recommended parameters reflecting the reason information to the generative AI server 200. Reflecting the reason information may include addressing an issue due to a rejection reason indicated in the reason information. In a case where the trained model 201 is configured to output recommended parameters reflecting reason information when the inputted data contains reason information, the API and prompt used by the CPU 11 in S315 may be the same as the API and prompt used by the CPU 11 in S205. The API and prompt used by the CPU 11 in S315 may also be different from the API and prompt used by the CPU 11 in S205 and may clearly specify that the reason information is to be incorporated.

The scan data transmitted by the CPU 11 in S315 is either the scan data generated in S212 when S212 is performed or the scan data generated in S202 when the parameters match. The scanning parameters sent by the CPU 11 in S315 may be the recommended parameters used in S212 when S212 is performed or the scanning parameters 22 used in S202 when the parameters match. The reason information sent to the generative AI server 200 is an example of the correction instruction data. The redo data including the reason information is an example of the correction instruction data. Part of the redo data when that part includes the reason information may be an example of the correction instruction data.

By sending the redo data to the generative AI server 200 in S315 that includes reason information based on the reason selected through a user operation, the CPU 11 is more likely to be able to receive recommended parameters in line with the user's intentions than those received the previous time. The CPU 11 may also send the redo data containing the parameter range information 23 to the generative AI server 200 in S315.

After sending the redo data to the generative AI server 200, in S317 the CPU 11 determines whether appropriate recommended parameters have been received in the response from the generative AI server 200. When the CPU 11 determines that appropriate recommended parameters have not been received (S317: NO), in S318 the CPU 11 determines whether to conclude that the settings process has failed. The determinations in S317 and S318 are identical to those in S207 and S208, respectively.

When the CPU 11 determines that appropriate recommended parameters have been received (S317: YES), in S319 the CPU 11 determines whether the recommended parameters received in the latest response are the same as the recommended parameters received in the previous response in S207. The determination in S319 is performed in a manner similar to that in S211. When the CPU 11 determines that the recommended parameters received in the latest response are the same as those received previously (S319: YES) or when the CPU 11 determines in S318 that appropriate recommended parameters have failed to be obtained from the generative AI server 200 (S318: YES) or when the CPU 11 determines in S302 that a user operation on the Cancel button 77 has been received through one of the confirmation screens 70A and 70B (S302: Cancel), in S321 the CPU 11 sets the settings result (flag) to “Failure,” discards information on the generated scan data and received recommended parameters, and ends the confirmation process. The instruction issued through an operation on the Cancel button 77 is an example of the cancel instruction.

When the CPU 11 receives recommended parameters identical to those received the previous time, the CPU 11 may inform the user that the same parameters have been recommended and confirm with the user whether to cancel the scan or to output the previous scan data. Alternatively, when the recommended parameters received in the current response are the same as those received in the previous response, the CPU 11 may resend the same redo data to the generative AI server 200 in S315 and repeat the request for recommended parameters reflecting the reason information.

On the other hand, when the CPU 11 determines that the current parameters differ from the recommended parameters received in the previous response (S319: NO), in S322 the CPU 11 executes a scan using the recommended parameters received in the current response. In other words, when the CPU 11 have sent recommended parameters received from the generative AI server 200 in the previous response and scan data scanned using these previous recommended parameters to the generative AI server 200 and receives recommended parameters based on this data, the CPU 11 rescans the document using the current recommended parameters. Thus, by sending the reason information, in particular, to the generative AI server 200, the output results are likely to be closer to the user's intentions.

After completing the scan in S322, the CPU 11 returns to S301 and displays the confirmation screen 70A or 70B on the user interface 13 based on the scan data generated in the scan of S322. In S302 the CPU 11 again accepts an operation on one of the OK button 75, Redo button 76, and Cancel button 77.

The CPU 11 continues to confirm results with the user until concluding that the settings result is “OK” (S303) or that the settings result is a “Failure” (S321). Once the CPU 11 has concluded that the settings result is “OK” or a “Failure,” the CPU 11 ends the confirmation process and returns to the auto settings process of FIG. 4.

The recommended parameters received from the generative AI server 200 may not always be in line with the user's intentions. When the user selected the “Auto Settings (with Confirmation)” button 62 in the AI support selection screen 60 (see FIG. 3B), the user can ultimately select whether to perform output based on the scan data, thereby restricting the CPU 11 from performing output based on the scan data not in line with the user's intentions. When the user has selected the “Auto Settings (without Confirmation)” button 61, on the other hand, the CPU 11 does not display the confirmation screen 70A or 70B (see FIG. 6) or accept instructions, saving the user time and effort. Thus, the MFP 1 permits more flexibility in processing by displaying the “Auto Settings (without Confirmation)” button 61 and “Auto Settings (with Confirmation)” button 62 and accepting a user selection on whether to output the scan data after the user has reviewed the results.

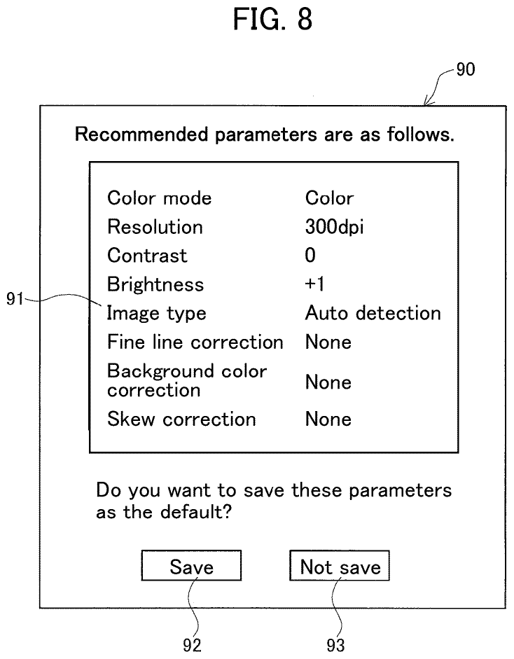

Returning to the description of the auto settings process in FIG. 4, in S221 the CPU 11 determines whether the setting result indicating “OK” is set in the confirmation process of S216. When the setting result indicating “OK” is set in the confirmation process (S221: YES), in S225 the CPU 11 displays a parameter screen on the user interface 13. FIG. 8 shows an example of a parameter screen 90 that the CPU 11 displays. In this example, the parameter screen 90 includes scanning parameters 91 used for generating the scan data determined to be “OK,” a Save button 92, and a Don't Save button 93. The CPU 11 then accepts an operation on one of the Save button 92 and Don't Save button 93.

When in S215 an operation on the “Auto Settings (without Confirmation)” button 61 has been received (S215: NO), in S225 the CPU 11 displays the parameter screen 90. In this case, the scanning parameters 91 are parameters used for generating the scan data in S212 when S212 is performed or parameters used for generating the scan data in S202 when parameters match (S211: YES). When the parameters match (the process of S212 is skipped) and NO determination is made in S215, the CPU 11 may skip the processes of S225, S226, and SS7, and end the auto settings process.

In S226 the CPU 11 determines whether an operation on the Save button 92 has been received in the parameter screen 90. When the CPU 11 determines that the operation on the Save button 92 has been received (S226: YES), in S227 the CPU 11 saves all parameters displayed as the scanning parameters 91 in the memory 12 as the scanning parameters 22. The CPU 11 may display parameters for all scanning related settings (scanning related setting items) in the parameter screen 90 or may display only those parameters that differ from the scanning parameters 22 stored in the memory 12.

Beginning from the next scan, in S201 the CPU 11 will read the parameters newly saved in the memory 12 as the scanning parameters 22 and use these parameters to perform the scan, as described above. Thus, when output based on scan data is determined to be “OK,” in the process of S227 the CPU 11 sets the scanning parameters 91 used for generating that scan data as the scanning parameters 22 to be used for executing the first scan in S202. A user selection received through an operation on the Save button 92 or the Don't Save button 93 is an example of the setting selection to select whether to set the parameter as a scan parameter.

When recommended parameters used for generating scan data determined to be “OK” are saved as the scanning parameters 22, the MFP 1 uses those parameters in the next scan of S202. Therefore, when the MFP 1 is scanning a document having a similar image in the next scan, in particular, the next scan of S202 is likely to produce suitable scanning results from the start. As a result, the possibility of the MFP 1 performing a rescan in S212 is reduced. Moreover, since the MFP 1 receives a selection indicating whether to save the recommended parameters as the scanning parameters 22, the user can choose whether to use the current recommended parameters for subsequent scans in S202.

When the scanning parameters 91 used for generating scan data determined to be “OK” match the scanning parameters 22 read in S201, the CPU 11 may neither display the parameter screen 90 nor accept a selection indicating whether to save the parameters.

Following the saving process of S227 or when the CPU 11 determines in S226 that an operation on the Don't Save button 93 is received (S226: NO), the CPU 11 ends the auto settings process. Further, when the CPU 11 determines in S221 that the settings result set in the confirmation process in S216 does not indicate “OK” (S221: NO), in S209 the CPU 11 sets a settings result (flag) of the auto settings process to indicate “Failure” and ends the auto settings process.

Returning to the description of the scanning process in FIG. 2, after completing the auto settings process of S114 the CPU 11 determines in S118 whether the settings result set in the auto settings process indicates “OK”. The CPU 11 makes a YES determination in S118 when the settings result indicates “OK”. The CPU 11 also makes a YES determination in S118 when an operation on the “Auto Settings (without Confirmation)” button 61 (FIG. 3B) has been received (S215: NO). When the settings result set in the auto settings process indicates “Failure” rather than “OK” (S118: NO), in S121 the CPU 11 reports the failure and subsequently ends the scanning process. In this case, the CPU 11 does not output scan data.

When the CPU 11 determines that the settings result set in the auto settings process indicates “OK” (S118: YES), in S122 the CPU 11 outputs the scan data for which an “OK” determination has been made. The CPU 11 also outputs the generated scan data in S122 after performing the normal scan process in S108. As the output process, the CPU 11 either saves image data based on the scan data or executes a print based on the scan data according to the user's instruction.

Specifically, when an operation on the Scan icon 52 has been received in S102 through the standby screen 50 (FIG. 3A), in S122 the CPU 11 accepts via the user interface 13 a designation of a save location as the destination for the scan data, and a designation of a file format in which the image data based on the scan data is to be saved. The CPU 11 then converts the image data based on the scan data to the designated file format and outputs the converted image data to the designated output destination. As an alternative, the CPU 11 may receive these designations for save location and file format prior to displaying the AI support selection screen 60 (see FIG. 3B).

Examples of output destinations for scan data are a USB memory mounted in the MFP 1, an information processing device connected to the MFP 1, an email recipient specified by an email address registered on the MFP 1, and cloud storage to which the MFP 1 can upload the scan data. Examples of file formats are JPEG, PDF, TIFF, and raw. Allowing such designations for output destination and file format can facilitate the user in using the saved scan data.

Alternatively, when an operation on the Copy icon 51 (FIG. 3A) is received in S102 through the standby screen 50 (see FIG. 3A), in S122 the CPU 11 uses the printing engine 15 to perform a print based on the scan data.

Following step S121 or S122, the CPU 11 ends the scanning process. Thereafter, the CPU 11 may return to S101 and redisplay the standby screen 50, for example.

Next, a procedure will be described for cases in which the user has selected the “Interactive”button 63 in the AI support selection screen 60 displayed in S111 (see FIG. 3B). When the CPU 11 receives an operation on the Execute button 65 and determines in S112 that the “Interactive” button 63 is selected (S112: Interactive), in S116 the CPU 11 executes an interactive process. The instruction that has been issued through the Execute button 65 while the “Interactive”63 has been selected is an example of the specific scan instruction.

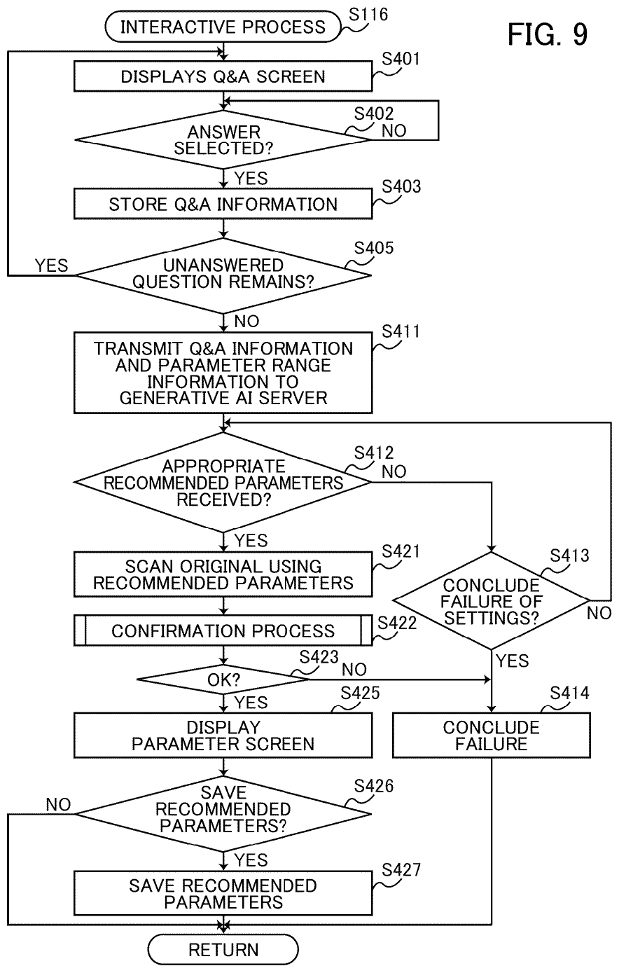

Steps in the interactive process will be described with reference to the flowchart in FIG. 9. In S401 of the interactive process, the CPU 11 displays a Q&A screen on the user interface 13 based on the questions and options information 24 (see FIG. 1) stored in the memory 12. The questions and options information 24 includes a plurality of questions for settings related to scanning parameters, and a plurality of options for each question. Each option indicates a possible answer to a corresponding question. The questions and options information 24 may also include questions related to characteristics of the document's image, and questions about the file format to be outputted based on the scan data. A single question may be relevant to a plurality of settings (setting items). Here, the question may indicate information related to scan settings in one category (one setting item) and information that prompts the user to input a request for that scan settings, as an answer. The option may indicate a possible answer to the corresponding question and information relevant to identifying the scan settings that satisfy the user's request.

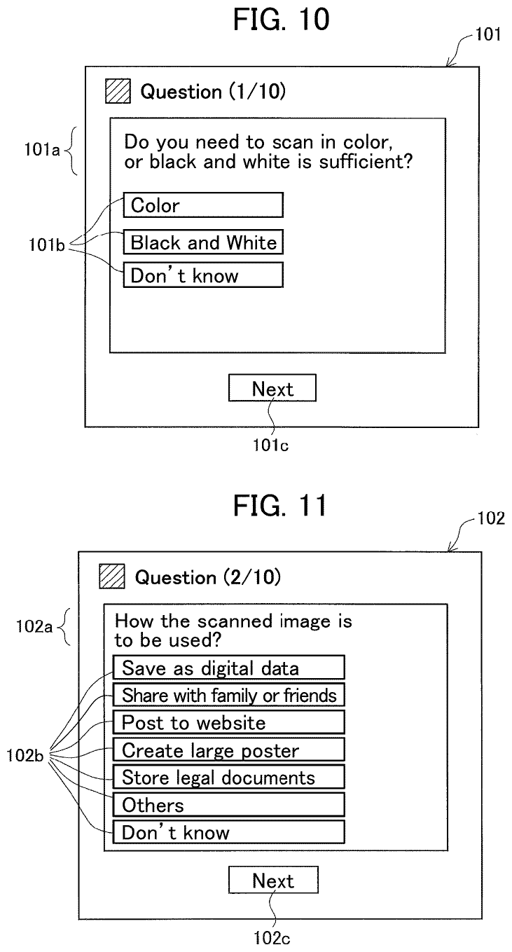

FIG. 10 shows an example of a Q&A screen 101 that the CPU 11 displays. In this example, the Q&A screen 101 includes one question 101a, a plurality of options 101b indicating possible answers to this question, and a Next button 101c that accepts an instruction to advance to the next question. The question 101a in the Q&A screen 101 relates to the color setting among the scanning parameters (a parameter for the color setting among the scanning parameters) and prompts the user to indicate whether to scan in color. The options 101b include the three selections: “Color,” “Black and white,” and “Don't know.” The question 101a is an example of the question related to color.

In S402 the CPU 11 accepts a selection of any one of the options 101b. Once one of the options 101b has been selected, the CPU 11 can accept an operation on the Next button 101c to confirm the selection. The CPU 11 continues to wait while the Next button 101c has not been operated (S402: NO). Once the selection is confirmed with the Next button 101c (S402: YES), in S403 the CPU 11 stores Q&A information indicating a combination of the question that has been displayed in S401 and the answer received to that question. The process of S402 is an example of the question process.

Thus, a user who has a request for color image data as the scanning results selects “Color” from the options 101b, and the CPU 11 stores Q&A information indicating that color reading is requested. Since the question and options for responding to that question are displayed in the screen, the user can easily answer the question. Note that the user may be able to select a plurality of answers from the plurality of options or may be allowed to select only one, and this ability to select more than one answer may differ depending on the question.

The Q&A information stored in S403 is sent to the generative AI server 200 in a later step and is used by the trained model 201 to determine recommended parameters. For example, it is likely that the recommended parameters will include “Color” as the parameter for the color setting when the Q&A information contains information indicating that “Color” is selected in the Q&A screen 101. Thus, by transmitting, to the generative AI server 200, Q&A information including information indicating whether color scanning is requested, the generative AI server 200 can be expected to return recommended parameters containing the appropriate parameter for the color setting (the color setting item).

The multiple options for each question include the option “Don't know,” indicating that the user is unsure of the answer. Requiring definitive answers to all questions might be burdensome for the user. Allowing the user to select “Don't know” when the answer is unclear reduces the user's burden. When the user selects “Don't know,” the CPU 11 may store information indicating that “Don't know” has been selected as Q&A information or may simply not store information related to questions for which “Don't know” has been selected. The option “Don't know”is an example of information indicating that the answer is unclear.

After the Next button 101c is operated, in S405 the CPU 11 determines whether at least one question remains. The CPU 11 displays each of the plurality of questions included in the questions and options information 24 in a Q&A screen one by one in sequence and receives an answer to each. When the CPU 11 determines at least one question remains (S405: YES), the CPU 11 returns to S401 and displays a Q&A screen with the next question. The CPU 11 accepts user input and stores the received information. The CPU 11 repeats the process in S401-S403 until an answer has been obtained for all questions in the questions and options information 24.

By repeatedly displaying a Q&A screen for each question that includes both the question and options for answering that question and receiving a response, the CPU 11 can facilitate the user in understanding the content of the questions and answering the questions. Moreover, by preparing multiple questions, it becomes more likely that the user's intentions will be made clearer and that the CPU 11 will obtain more appropriate recommended parameters increase. Rather than switching the screen for each question, the CPU 11 may instead display a plurality of questions in one screen. Further, rather than displaying the Next button 101c, the CPU 11 may automatically advance to the next Q&A screen after one of the options 101b has been selected. The Q&A screen may further include a Back button, and the CPU 11 may return to the previous Q&A screen when the Back button is operated.

The questions and options information 24 may also include an application question prompting the user to indicate the intended use of the scan data. In this case, the CPU 11 may display a Q&A screen 102, as shown in the example of FIG. 11. The Q&A screen 102 includes a question 102a regarding how the scanned image is to be used, various options 102b indicating different types of applications, and a Next button 102c. The CPU 11 then accepts a user selection of one of the options 102b. For example, the trained model 201 can likely determine the scanning resolution, file format, and need for image correction, based on the application of the scan data. By sending Q&A information containing the application of the scan data to the generative AI server 200, the generative AI server 200 can be expected to return recommended parameters that include an appropriate resolution, file format, and need for image correction.

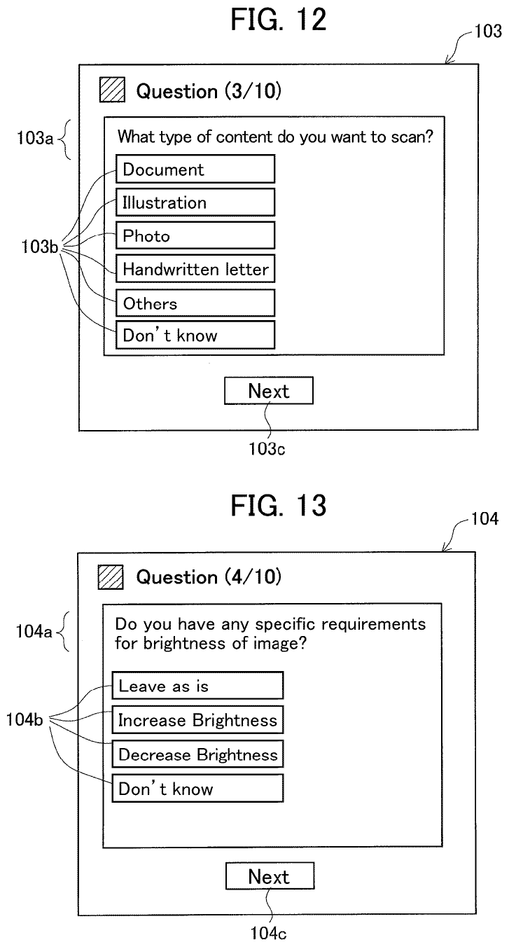

The questions and options information 24 may also include various questions prompting the user to indicate the type of image being scanned. In this case, the CPU 11 displays a Q&A screen 103, such as that shown in FIG. 12. In this example, the Q&A screen 103 includes a question 103a asking what the user wishes to scan (asking a type of image to be scanned), a plurality of options 103b specifying different types of images, and a Next button 103c. The CPU 11 then accepts a user selection. Based on the selected type of image to be scanned, the trained model 201 can likely determine whether to perform color scanning and what type of image correction is needed. By sending Q&A information containing the type of image to the generative AI server 200, the CPU 11 can expect to receive recommended parameters from the generative AI server 200 that indicate the appropriate image type, resolution, color selection, and need for image correction.

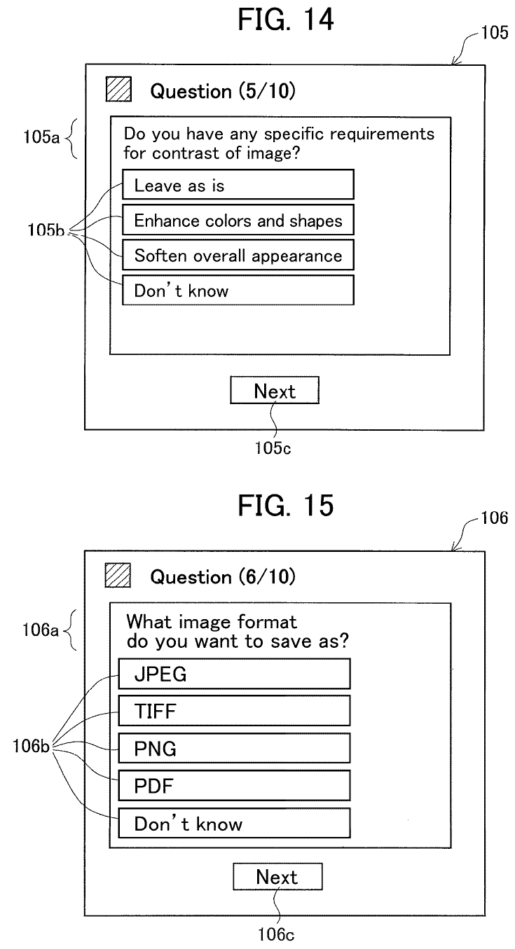

The questions and options information 24 may also include a brightness question prompting the user to indicate the brightness intensity, and a contrast question prompting the user to indicate the contrast intensity. In this case, the CPU 11 displays Q&A screens 104 and 105, as shown in the examples of FIGS. 13 and 14. The Q&A screens 104 and 105 include respective questions 104a and 105a inquiring about the user's desired brightness and contrast, options 104b and 105b specifying desired adjustments for brightness and contrast, and Next buttons 104c and 105c. After displaying each Q&A screen, the CPU 11 accepts a user selection. Based on the user's selections, the trained model 201 can likely set suitable intensities for brightness and contrast. Thus, by sending Q&A information containing brightness and contrast intensities to the generative AI server 200, the CPU 11 can expect to receive recommended parameters from the generative AI server 200 that indicate appropriate brightness and contrast intensities.

The questions and options information 24 may also include a format question prompting the user to indicate the file format of the file to be outputted based on the scan data. In this case, the CPU 11 displays a Q&A screen 106, such as that shown in FIG. 15. In this example, the Q&A screen 106 includes a question 106a asking the format in which the image is to be saved, various options 106b indicating different file formats, and a Next button 106c. When the questions and options information 24 does not include a file format question such as that shown in FIG. 15, the CPU 11 may set the file format based on answers to other questions.

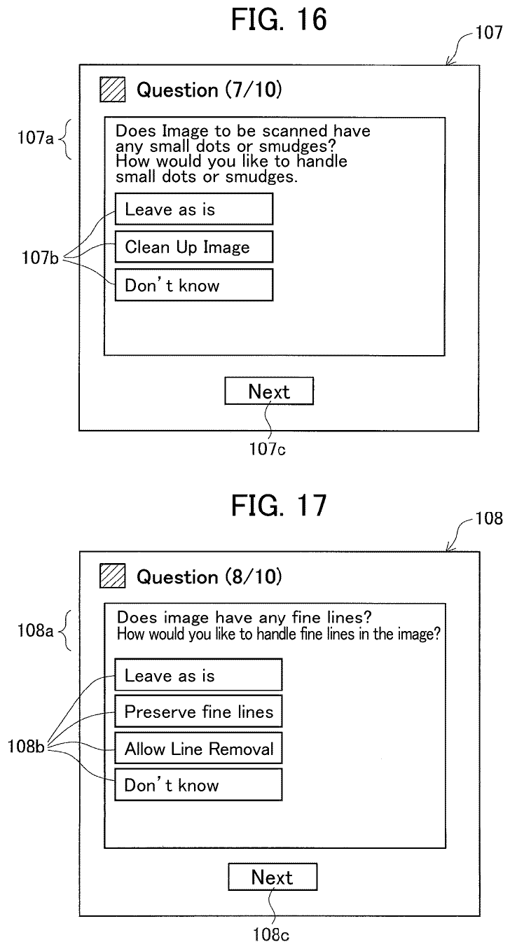

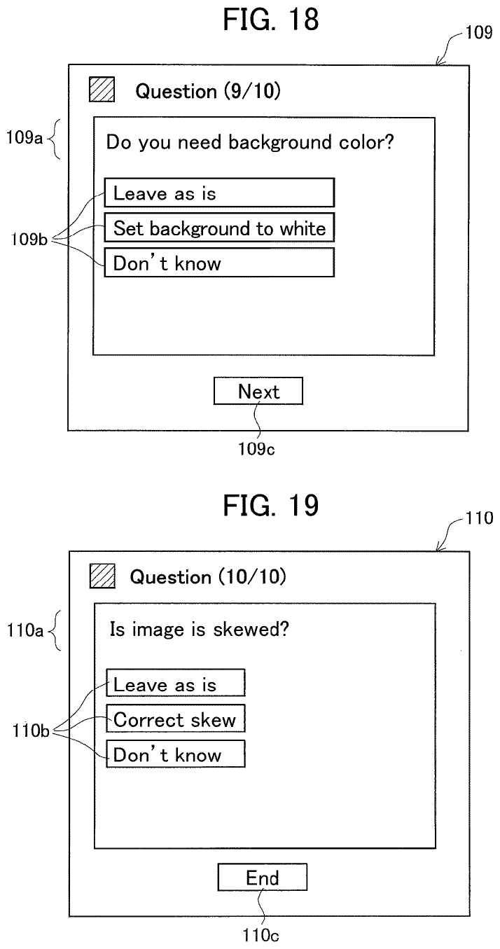

The questions and options information 24 may also include correction questions prompting the user to indicate whether each of various types of image correction is needed. In this case, the CPU 11 displays various Q&A screens with correction questions, such as the Q&A screens 107, 108, 109, and 110 in FIGS. 16 through 19. In this example, the Q&A screen 107 includes a question 107a inquiring whether the image to be scanned has any small dots or smudges, options 107b regarding factors used to determine whether to perform noise cancellation, and a Next button 107c. The Q&A screen 108 includes a question 108a inquiring whether the image has any fine lines, options 108b regarding factors to determine whether to perform fine line correction and determine correction level of the fine line correction if performed, and a Next button 108c. The Q&A screen 109 includes a question 109a inquiring whether to perform the background color correction of the image, options 109b regarding factors used to determine whether to perform background color correction and determine how background color correction is performed, and a Next button 109c. The Q&A screen 110 includes a question 110a inquiring whether the image is skewed, and options 110b regarding factors used to determine whether to perform skew correction. By accepting answers regarding factors used to determine whether to perform various types of image correction and sending Q&A information including the user's responses on the determination factors of the image corrections to the generative AI server 200, the CPU 11 can expect to receive recommended parameters from the generative AI server 200 that contain appropriate information indicating whether to perform image corrections.

Note that the Q&A screen displaying the last question stored in the questions and options information 24 contains an End button 110c rather than a Next button. In this way, the user can readily understand that the question 110a is the final question.

Once the CPU 11 determines that no questions remain, i.e., that Q&A information has been stored for all of the questions (S405: NO), in S411 the CPU 11 transmits various data to the generative AI server 200 including the stored Q&A information and the parameter range information 23. That is, in S411 the CPU 11 instructs the generative AI server 200 to analyze the various data using the trained model 201 and to return recommended parameters within the ranges specified in the parameter range information 23. For convenience, the data transmitted by the CPU 11 in S411 will be called Q&A transmission data. The parameter range information 23 is an example of information indicating a setting item corresponding to a parameter to be used for a scan. The process of S411 is an example of the question and answer transmitting process. The data that the CPU 11 transmits in S411 may be referred to as the question-and-answer transmission data.

The CPU 11 may also instruct the generative AI server 200 to return recommended parameters reflecting the Q&A information by sending the Q&A transmission data to the generative AI server 200 via a dedicated API. Alternatively, the CPU 11 may instruct the generative AI server 200 to return recommended parameters reflecting the Q&A information by sending the Q&A transmission data and a prompt specifying the instructions to the generative AI server 200. When the trained model 201 is configured to output recommended parameters reflecting Q&A information when the inputted data contains Q&A information, the API and prompt used by the CPU 11 in S411 may be the same as the API and prompt used by the CPU 11 in S205. The API and prompt used by the CPU 11 in S411 may also be different from the API and prompt used by the CPU 11 in S205 and may clearly specify that the Q&A information is to be incorporated when generating recommended parameters.

After transmitting the various data in S411, in S412 the CPU 11 determines whether appropriate recommended parameters have been received in the response from the generative AI server 200. When the CPU 11 determines that appropriate recommended parameters have not been received (S412: NO), in S413 the CPU 11 determines whether to conclude that the settings process has failed and returns to S412 when reaching a NO determination (S413: NO). The determination in S313 may be performed in a manner similar to S208. When the CPU 11 determines that the settings process has failed (S413: YES), in S414 the CPU 11 sets a settings result (flag) of this interactive process to indicate “Failure,” discards the Q&A information, and ends the interactive process. The determinations in S412 and S413 are identical to those in S207 and S208 shown in FIG. 4, respectively.

When the CPU 11 determines that appropriate recommended parameters have been received (S412: YES), in S421 the CPU 11 controls the scanning engine 16 to scan an image of the document and generate scan data using the recommended parameters received in S411. The process of S421 is an example of the recommended scan process. The scan data generated in S421 is an example of the recommended scan data.

After performing the scan in S421, in S422 the CPU 11 executes the confirmation process to have the user confirm the generated scan data. The confirmation process of S422 is performed in a manner similar to the confirmation process of S216 shown in FIG. 5. In the interactive process, the CPU 11 displays an image of the scanning results and the recommended parameters on the user interface 13 and accepts output instructions from the user before outputting the results. Therefore, the CPU 11 restricts outputting scanning results not in line with the user's intentions.

In S423 the CPU 11 then determines whether the settings result set in the confirmation process in S422 indicates “OK.” When the CPU 11 determines that the settings result set in the confirmation process in S422 indicates “Failure” and not “OK” (S423: NO), in S414 the CPU 11 determines that appropriate recommended parameters could not be acquired from the generative AI server 200 (i.e., sets the settings result of the interactive process to indicate “Failure”), discards information on the generated scan data and the received recommended parameters, and ends the interactive process.

However, when the CPU 11 determines that the settings result set in the confirmation process in S422 indicates “OK” (S423: YES), in S425 the CPU 11 displays the parameter screen 90 on the user interface 13 (see FIG. 8) and in S426 accepts a user selection as to whether to save the recommended parameters.

When the CPU 11 determines that an operation on the Save button 92 has been received (S426: YES), in S427 the CPU 11 saves all parameters displayed as the scanning parameters 91 in the memory 12 as the scanning parameters 22. Following the saving process of S427 or when the CPU 11 determines in S426 that an operation on the Don't Save button 93 has been received (S426: NO), the CPU 11 ends the interactive process. Steps S425 through S427 are identical to steps S225 through S227 in the auto settings process.

In the interactive process, the MFP 1 outputs scanning-related questions and receives answers to those questions prior to executing the scan. By transmitting the content of these questions and their answers to the generative AI server 200 employing the trained model 201, the CPU 11 can receive recommended parameters determined by the trained model 201 from the generative AI server 200. According to this procedure, the MFP 1 sends Q&A information to the generative AI server 200 based on user responses to scanning-related questions without first executing a scan, unlike in the auto settings process. Therefore, the MFP 1 can expect to receive appropriate recommended parameters based on this Q&A information. In other words, having the user answer questions about the document's image will increase the likelihood that the user will obtain output results based on parameters appropriate for the document's image.

Returning to the description of the scanning process in FIG. 2, after completing the interactive process in S116, the CPU 11 performs the same process performed after completion of the auto settings process. That is, when the settings result set in the interactive process indicates “Failure” (S118: NO), in S121 the CPU 11 reports the failure and subsequently ends the scanning process. When the CPU 11 determines that the settings result set in the interactive process indicates “OK” (S118: YES), in S122 the CPU 11 outputs the scan data for which the “OK”determination has been made in S118.

As described above in detail, when an auto settings process is selected, the MFP 1 scans the document and sends the scan data generated in that scan along with the scanning parameters 22 used in that scan to the generative AI server 200, which uses the trained model 201. Since the trained model 201 has been trained to output recommended parameters, the MFP 1 is likely to be able to receive recommended parameters from the generative AI server 200. After receiving the recommended parameters set by the trained model 201 from the generative AI server 200, the MFP 1 rescans the document according to the received recommended parameters to generate scan data and then performs output based on that scan data. Thus, it is likely that this process will produce output results based on parameters suited to the document's image without requiring the user to input information on the type of image.

When the interactive process is selected, on the other hand, the MFP 1 outputs scanning-related questions, receives responses from the user, and sends Q&A information associating the questions with their answers to the generative AI server 200, which uses the trained model 201. Since the trained model 201 has been trained to output recommended parameters, it is likely that the MFP 1 can receive recommended parameters from the generative AI server 200. After receiving recommended parameters set by the trained model 201 from the generative AI server 200, the MFP 1 scans the document using these recommended parameters to generate scan data, and then performs output based on this scan data. Through this process, even a user who has no understanding of scanning-related parameters can likely obtain output results suited to the document.

While the invention has been described in conjunction with various example structures outlined above and illustrated in the figures, various alternatives, modifications, variations, improvements, and substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and or substantial equivalents. Some specific examples of potential alternatives, modifications, or variations in the described invention are described below:

For example, the scanner is not limited to the MFP 1 but may be a copier, a fax machine, or any other device having an image reading function and a communication function.

The display formats of this embodiment are also not limited to the examples in the drawings. For example, the number, types, and shapes of icons displayed in the standby screen 50 are not limited to the example in FIG. 3A. The AI Support button 53 may be omitted. The MFP 1 may be configured to always perform processes with AI support or may display copy and scan icons with AI support and copy and scan icons without AI support in the standby screen 50. Further, the AI support selection screen 60 shown in FIG. 3B may be any screen that can accept user selections, and the shapes of buttons in the AI support selection screen 60 are not limited to the format in this diagram.

In the above embodiment, the MFP 1 sends the parameter range information 23 to the generative AI server 200 in S205 of the auto settings process (see FIG. 4) and in S411 of the interactive process (see FIG. 9), but the MFP 1 may not send the parameter range information 23. For example, when the recommended parameters received from the generative AI server fall outside ranges in the parameter range information 23, the MFP 1 may send the parameter range information 23 and request recommended parameters again. That is, when the CPU 11 reaches a NO determination in S207 of FIG. 4, for example, the MFP 1 may send transmission data containing the parameter range information 23 to the generative AI server 200. The MFP 1 may also send Q&A transmission data containing the parameter range information 23 to the generative AI server 200 when a NO determination is reached in S412 of FIG. 9.

The determination in S211 of the auto settings process (see FIG. 4) and the determination in S319 of the confirmation process (see FIG. 5) may also be omitted. In other words, upon receiving recommended parameters, the MFP 1 may rescan the document using the recommended parameters, even when they are the same parameters as those used in a previous scan.

In the confirmation process of the embodiment (see FIG. 5), the MFP 1 toggles the display between the confirmation screen 70A shown in FIG. 6A and the confirmation screen 70B shown in FIG. 6B in response to operations on buttons, but the MFP 1 may display a single screen containing both the image 71 and the parameter information 73. The Cancel button 77 may also be omitted from the confirmation screens. In this case, the MFP 1 may repeatedly request recommended parameters until the OK button 75 is operated, for example. Further, while the MFP 1 always performs the confirmation process in the interactive process of the above embodiment, the MFP 1 may not perform this process or may accept a user selection as to whether to confirm.

In the embodiment described above, the MFP 1 displays the rejection reason selection screen 80 (see FIG. 7) and the Q&A screens 101-110 (see FIGS. 10-19) on the user interface 13 and receives selections from among the respective options as a process for learning the user's wishes, but the MFP 1 is not limited to this process. For example, the MFP 1 may output questions in audio and accept answers through voice input. In this case, the MFP 1 may send voice data based on the voice input to the generative AI server 200. The MFP 1 may also allow the user to enter any response without being constrained by the displayed options.

The questions and their response options shown in the Q&A screens 101-110 (see FIGS. 10-19) are merely examples, and the present invention is not limited to these examples. When “Color” is selected in the Q&A screen 101 (FIG. 10), for example, the MFP 1 may output additional questions related to color tones (hue, and saturation).

S225-S227 of the auto settings process (see FIG. 4) and S425-S427 of the interactive process (see FIG. 9) may also be omitted. In this case, the MFP 1 may not store the recommended parameters in the memory 12 at any time. Alternatively, in this case, the MFP 1 may always store the recommended parameters. In a case where the MFP 1 stores the recommended parameters, the MFP 1 may store the recommended parameters after performing output based on the scan data. The MFP 1 may also be configured to accept a selection indicating whether to save the recommended parameters as part of the scan settings prior to receiving the recommended parameters.

The MFP 1 is configured to be capable of performing both the auto settings process (see FIG. 4) and the interactive process (see FIG. 9) in the above embodiment. However, the MFP 1 may not be configured to perform an auto settings process. In this case, the AI support selection screen 60 (see FIG. 3B) may include only the “Interactive” button 63. Alternatively, the MFP 1 may simply execute the interactive process when the user selects “Copy” or “Scan” while AI support is “ON”.

The above embodiment describes a procedure in which the MFP 1 generates scan data using the scanning engine 16 included in the MFP 1 and transmits the scan data to the generative AI server 200 via the communication interface 14 included in the MFP 1. However, the generation of scan data and the transmission of scan data may be performed by separate devices. For example, scan data generated by a scanner may be received by a terminal device, such as a personal computer and a smartphone, separate from the scanner. In this case, the terminal device sends the received scan data to the generative AI server 200 via a communication interface in the terminal device.

In the interactive process of the above embodiment, the MFP 1 displays questions and options for their answers on the user interface 13 and prompts the user to make selections, but a device other than the MFP 1 may present the questions and acquire the responses. For example, the terminal device running a prescribed application program may ask questions to acquire Q&A information and may transmit the acquired Q&A information to the MFP 1. Alternatively, the terminal device may send the Q&A information to the generative AI server 200 directly.

The generative AI server 200 is not limited to being a server that possesses the trained model 201 but may be capable of accessing the trained model 201 on another server. In such a case, the generative AI server 200 transfers the various data received from the MFP 1 to the other server possessing the trained model 201 and sends response data to the MFP 1 based on the response received from this trained model 201.

The above embodiment describes a configuration using the trained model 201 of the generative AI server 200, but the present disclosure may also be applied to a configuration using a program generated based on programming code by a programmer, instead of the trained model 201.

In any of the flowcharts or sequence diagrams disclosed in the embodiment, the plurality of processes included in any of a plurality of steps may be executed in parallel, or the order in which the processes are performed may be modified in any way that does not produce any inconsistencies in the processes.

The processes in the present disclosure are performed by a single CPU, a plurality of CPUs, hardware such as one or more Application Specific Integrated Circuits (ASICs), or any combination of these components. The discloses processes are achieved through a computer-readable storage medium storing programs used to implement those processes or according to any methods or formats for performing those processes. The term “processor” encompasses both a single processor or a group of multiple processors located either locally or remotely working together or in a distributed fashion to collectively perform the tasks attributed to the “processor”described herein. One or more processors may be referred to as a controller.

Note that the present disclosure includes the phrases such as “at least one of A and B”, “at least one of A, B and C”, as alternative expressions that mean one or more of A and B, one or more of A, B and C, respectively. More specifically, the phrase “at least one of A and B” indicates (A), (B) or (A and B), and the phrase “at least one of A, B and C” indicates (A), (B), (C), (A and B), (A and C), (B and C) or (A, B and C).

What is claimed is:

1. A scanner comprising:
a scanning engine;
a user interface;
a communication interface; and
a controller including one or more processors, the controller being configured to perform:
a questioning process under a condition including a requirement that a specific scan instruction is received through the user interface, the questioning process including:
outputting one or more questions related to generation of scan data through the user interface; and
receiving one or more answers through the user interface, each of the one or more answers being an answer to a corresponding one of the one or more questions;
a question-and-answer transmission process including:
transmitting question-and-answer information to a server through the communication interface, the question-and-answer information including the one or more questions and the one or more answers, the question-and-answer information associating each of the one or more questions with a corresponding one of the one or more answers;
a first scan process under a first scan start condition including a requirement that a first recommended parameter set is received from the server through the communication interface, the first recommended parameter set being outputted by a trained machine learning model based on the question-and-answer information, the first scan process being based on the first recommended parameter set, the first scan process including:
reading an original using the scanning engine to generate first scan data; and
a first outputting process under a first outputting condition, the first outputting process including:
outputting a first object, the first object being the first scan data or an object based on the first scan data.

2. The scanner according to claim 1,
wherein the question-and-answer transmission process further includes:
transmitting range information to the server through the communication interface in association with the question-and-answer information so that the trained machine learning model can output the first recommended parameter set including a parameter within a range indicated in the range information.

3. The scanner according to claim 1,
wherein the controller is configured to further perform:
a displaying process under a condition including a requirement that the first scan process is completed, the displaying process including:
displaying a confirmation screen on the user interface, the confirmation screen presenting the first recommended parameter set and an image based on the first scan data, the confirmation screen being a screen through which an output instruction can be received,
wherein the first outputting process is performed under the first outputting condition including a requirement that the output instruction is received through the confirmation screen.

4. The scanner according to claim 1,
wherein the controller is configured to further perform:
a first displaying process under a condition including a requirement that the first scan process is completed, the first displaying process including:
displaying a first confirmation screen on the user interface, the first confirmation screen presenting the first recommended parameter set and an image based on the first scan data, the first confirmation screen being a screen through which either one of a first output instruction or a first modification instruction can be received,
wherein the first outputting process is performed under the first outputting condition including a requirement that the first output instruction is received through the first confirmation screen,
wherein the controller is configured to further perform:
a transmission process under a transmission condition including a requirement that the first modification instruction is received through the first confirmation screen, the transmission process including:
transmitting the first recommended parameter set and the first scan data to the server through the communication interface;
wherein the first outputting process is not performed under the transmission condition,
wherein the controller is configured to further perform:
a second scan process under a second scan start condition including a requirement that a second recommended parameter set is received from the server through the communication interface following the transmission process, the second recommended parameter set being outputted by the trained machine learning model based on the first recommended parameter set and the first scan data, the second scan process being based on the second recommended parameter set, the second scan process including:
reading the original using the scanning engine to generate second scan data;
a second displaying process under a condition including a requirement that the second scan process is completed, the second displaying process including:
displaying a second confirmation screen on the user interface, the second confirmation screen presenting the second recommended parameter set and an image based on the second scan data, the second confirmation screen being a screen through which a second output instruction can be received; and
a second outputting process under a second outputting condition including a requirement that the second output instruction is received through the second confirmation screen, the second outputting process including:
outputting a second object, the second object being the second scan data or an object based on the second scan data.

5. The scanner according to claim 1,
wherein the controller is configured to further perform:
a first displaying process under a condition including a requirement that the first scan process is completed, the first displaying process including:
displaying a first confirmation screen on the user interface, the first confirmation screen presenting the first recommended parameter set and an image based on the first scan data, the first confirmation screen being a screen through which either one of a first output instruction or a first modification instruction can be received,
wherein the first outputting process is performed under the first outputting condition including a requirement that the first output instruction is received through the first confirmation screen,
wherein the controller is configured to further perform:
a modification-content receiving process under a modification condition including a requirement that the first modification instruction is received through the first confirmation screen, the modification-content receiving process including:
receiving modification-content information through the user interface, the modification-content information being related to modification content of the first recommended parameter set; and
a transmission process under a transmission condition including a requirement that the modification-content receiving process is completed, the transmission process including:
transmitting the first recommended parameter set, the first scan data, and instruction information to the server through the communication interface, the instruction information being the modification-content information or information based on the modification-content information;
wherein the first outputting process is not performed under the modification condition,
wherein the controller is configured to further perform:
a second scan process under a second scan start condition including a requirement that a second recommended parameter set is received from the server through the communication interface following the transmission process, the second recommended parameter set is outputted by the trained machine learning model based on the second recommended parameter set, the first scan data, and the instruction information, the second scan process being based on the second recommended parameter set, the second scan process including:
reading the original using the scanning engine to generate second scan data;
a second displaying process under a condition including a requirement that the second scan process is completed, the second displaying process including:
displaying a second confirmation screen on the user interface, the second confirmation screen presenting the second recommended parameter set and an image based on the second scan data, the second confirmation screen being a screen through which a second output instruction and a second modification instruction can be received,
a second outputting process under a second outputting condition including a requirement that the second output instruction is received through the second confirmation screen, the second outputting process including:
outputting a second object, the second object being the second scan data or an object based on the second scan data.

6. The scanner according to claim 1,
wherein the outputting in the questioning process includes:
displaying a question screen presenting one of the one or more questions and a plurality of options each indicating a possible answer to the one of the one or more questions,
wherein the receiving in the questioning process includes:
receiving a selection of one of the plurality of options as a corresponding one of the one or more answers to the one of the one or more questions.

7. The scanner according to claim 1,
wherein the one or more questions include a plurality of questions and the one or more answers include a plurality of answers,
wherein the outputting in the questioning process includes:
displaying a plurality of question screens on the user interface, each of the plurality of question screens presenting a corresponding question of the plurality of questions, and a plurality of options indicating possible answers to the corresponding question,
wherein the receiving in the questioning process includes:
receiving selections of the plurality of answers through the plurality of question screens,
wherein the question-and-answer information includes the plurality of questions and the plurality of answers and associates each of the plurality of questions with a corresponding one of the plurality of answers.

8. The scanner according to claim 7,
wherein the displaying the plurality of question screens is performed by sequentially displaying the plurality of question screens on the user interface,
wherein the receiving the selections of the plurality of answers is performed by receiving a selection of one of the plurality of options presented in each of the plurality of question screens as an answer to the corresponding question presented in the each of the plurality of question screens.

9. The scanner according to claim 1,
wherein the one or more questions include a first question and a second question, the first question being related to a first category of settings for scanning the original, the second question being related to a second category of settings for scanning the original, the second category being different from the first category,
wherein the first recommended parameter set includes a first parameter associated with the first category and a second parameter associated with the second category,
wherein the question-and-answer transmission process further includes:
transmitting category information to the server through the communication interface in association with the question-and-answer information so that the trained machine learning model can output the first recommended parameter set based on the category information, the category information including information related to the first category and information related to the second category.

10. The scanner according to claim 1,
wherein the one or more questions include a subject question for obtaining, as an answer to the subject question, information regarding whether to perform a color scan.

11. The scanner according to claim 1,
wherein the one or more questions include a subject question for obtaining, as an answer to the subject question, information related to an intended use of the first scan data.

12. The scanner according to claim 1,
wherein the one or more questions include a subject question for obtaining, as an answer to the subject question, information related to an image type of the original.

13. The scanner according to claim 1,
wherein the one or more questions include a subject question for obtaining, as an answer to the subject question, information related to a brightness level of an image of the first scan data.

14. The scanner according to claim 1,
wherein the one or more questions include a subject question for obtaining, as an answer to the subject question, information related to a contrast level of an image of the first scan data.

15. The scanner according to claim 1,
wherein the one or more questions include a subject question for obtaining, as an answer to the subject question, information related to a file format of the first scan data.

16. The scanner according to claim 1,
wherein the one or more questions include a subject question for obtaining, as an answer to the subject question, information regarding whether to perform an image correction for generating the first scan data.

17. The scanner according to claim 1,
wherein the receiving in the questioning process can receive, as an answer to a subject question of the one or more questions, information indicating that the subject question cannot be answered.

18. The scanner according to claim 1,
wherein the controller is configured to further perform:
a storage location receiving process including:
receiving location information indicating a storage location through the user interface,
wherein the outputting in the first outputting process includes:
storing, as the first object, image data in the storage location indicated in the location information, the image data being based on the first scan data.

19. The scanner according to claim 18,
wherein the controller is configured to further perform:
a format receiving process including:
receiving format information indicating a file format through the user interface,
wherein the outputting in the first outputting process includes:
converting the first scan data into the image data in the file format indicated in the format information.

20. The scanner according to claim 1, further comprising:
a printing engine,
wherein the outputting in the first outputting process includes:
printing, as the first object, an image on a sheet based on the first scan data using the printing engine.
